(19) United States
(12) Patent Application Publication
(10) Pub. No.: US 2005/0081776 A1
(43) Pub. Date: Apr. 21, 2005

(54) Passage bookmark with pen holder

(76) Inventor: Deborah Lynn Moranville, Pittsburg, CA (US)

Correspondence Address: Deborah L. Moranville, 131 Pheasant Circle, Pittsburg, CA, 14343, US

(21) Appl. No.: 10/964,672

(22) Filed: Oct. 15, 2004

Related U.S. Application Data
(60) Provisional application No. 60/511,676, filed on Oct. 17, 2003.

(51) Int. Cl. B42D 9/00

(52) U.S. Cl. 116/238

(57) ABSTRACT

A combination bookmark and writing instrument holder, which is equipped with a plurality of narrow fabric markers which are utilized to mark multiple pages within a book. The bookmark, when attached to a book, is located on the outside of a book's spine, making the writing instrument easily accessible. The bookmark is made adjustable by use of one anchor strap and one short strap which secures two rings. The adjustable feature makes the bookmark useable on different size books and also makes the bookmark easy to remove from one book for use on another book. The preferred embodiment of the invention would incorporate fabric or leather for the front and back elements, and ribbons of various types and sizes for the narrow fabric markers. Beads, charms and the like may be used to differentiate the narrow fabric markers.

### CROSS-RERENCED TO RELATED APPLICATIONS

Provisional Application #: 60/511,676

Filing Date: Oct. 17, 2003

Name of Applicant: Deborah Lynn Moranville

Title of Invention: Attachable Passage Bookmark with Pen Pocket

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. The Field of Invention

This invention pertains to bookmarks and the means by which an adjustable bookmark may be temporarily attached to the outer spine of a book, and further, how said bookmark may provide a means for marking a multiple of pages contained in the book, and further, how said bookmark can provide a pocket to hold a writing instrument.

2. Description of Related Art

Bookmarks available today are of various shapes and sizes and materials. Examples of materials used may include, but are not limited to paper products, metal, fabric and plastic. Embellishments of all kinds exist. The majority of bookmarks are flat and their utility lies in a reader placing the bookmark between the pages of a book in order to mark where the reader has ended their reading session. Flat bookmarks are easily hidden in the pages of a book, misplaced, or lost. Other attempts have been made to provide a bookmark equipped with a plurality of straps for marking multiple pages in a book, examples of which can be viewed in U.S. Pat. No. 5,022,342 and U.S. Pat. No. 5,443,029. These bookmarks attach to books by various means including, clamps, VELCRO-type hook and loop fastener material and adhesives. Clamps may damage the book's binding, while adhesives render the bookmark, and or it's parts, permanently attached to the book.

Other bookmarks provide a means by which to attach a writing instrument to the bookmark, examples of which can be viewed in U.S. Pat. No. 4,162,800, U.S. Pat. No. 5,016,559 and U.S. Pat. No. 5,095,846.

Flat bookmarks mark only one page. Bookmarks attached by clamps or utilizing adhesives may damage or permanently alter the book's binding. Existing bookmarks providing a means to attach a writing instrument are not presently incorporated into bookmarks providing a plurality of straps for marking multiple pages.

A bookmark incorporating the features of temporary and adjustable attachment to a book, a plurality of straps for marking multiple pages and the means to attach a writing instrument to the bookmark, would fulfill multiple needs of readers. The advantages of such a bookmark being especially useful to students, book club members, individuals engaged in bible study programs, cooks, and all others having the need to mark several pages within a single book for quick reference, as well as the need to use an easily accessible writing instrument for notations, comments, etc.

### BRIEF SUMMARY OF THE INVENTION

The Attachable Passage Bookmarker with Pen Pocket is placed on the outside of the book's spine and held in place by an adjustable anchor strap, which is affixed to the top edge of the bookmark. The anchor strap is placed over the top of the book's spine, in a centered position, halfway through the book's pages. The strap is then placed between the book's pages, with the strap's free end extending downward, parallel to the book's spine and beyond the lower edge of the book's pages. Accessible from the lower portion on the backside of the bookmark are two rings. The anchor strap's free end wraps around the bottom of the book's spine towards the backside of the bookmark. The anchor strap's free end passes through the first ring and then the second ring. The anchor strap's free end then reverses direction, bypassing over the second ring and then passing back through the first ring. The anchor strap is then adjusted, being pulled taut, taking up the slack thereby securing the bookmark to the outer spine of the book. The adjustability of the anchor strap provides for securing the bookmark to a variety of different book sizes. The adjustability also provides a means to easily remove the bookmark from one book and place it on another book. Affixed to the top edge of the bookmark are a plurality of narrow fabrics; each of various lengths and defining characteristics, such as color, charms or beads, providing a means to clearly mark and distinguish a multiple of pages. The front face of the bookmark is equipped with a pocket to accommodate either a writing/highlighting instrument or reading glasses. The present invention is suitable for both hardback books and paperback books. It is fully adjustable and detachable; leaving no parts permanently attached to the book's spine.

### BRIEF DESCRIPTION OF THE SEVERAL VIEWS OF THE DRAWING

FIG. 1 is a perspective view of the Attachable Passage Bookmark with Pen Pocket. The bookmark is shown attached to the spine of a book and being used to mark pages in that book.

FIG. 2 is a perspective view of the bookmark, which is attached to a book, with the book shown in an open position.

FIG. 3 is a perspective view, which is an enlarged close up of the bookmark, which is attached to a book shown in an open position. The view is of the upper spine of the book.

FIG. 4 is a front view of the bookmark showing the front pen pocket, the adjustable strap and the narrow fabric markers.

FIG. 5 is a back view of the bookmark showing the adjustable strap, the narrow fabric markers, and the two rings through which the adjustable strap passes.

FIG. 6 is a back view of the bookmark with the adjustable strap and narrow fabric markers shown in partial view at the top upper portion of the bookmark. This view shows the two rings through which the adjustable anchor strap passes.

FIG. 7 is a side view of the bookmark.

FIG. 8 is a view of the topside of the front piece, which shows the pen pocket.

FIG. 9 is a view of the adjustable anchor strap and narrow fabric markers, which are attached to the stabilizing piece.

FIG. 10 is a view of the short length strap and two rings.

FIG. 11 is a view of the underside of the front piece, showing the adjustable strap and narrow fabric markers, which are attached to the stabilizing piece, the short length strap and two rings.

FIG. 12 is a view of the underside of the back.

FIG. 13 is a view showing the placement of underside of front piece joined together with the underside of back piece.

### DRAWING REFERENCE NUMERALS

1 book

2 front piece of bookmark

3 front pocket piece

4 adjustable anchor strap

5 narrow fabric markers

6 back piece of bookmark

7 rings

8 stabilizing piece

9 short length strap

10 writing instrument

11 bead

### DETAILED DESCRIPTION OF THE INVENTION

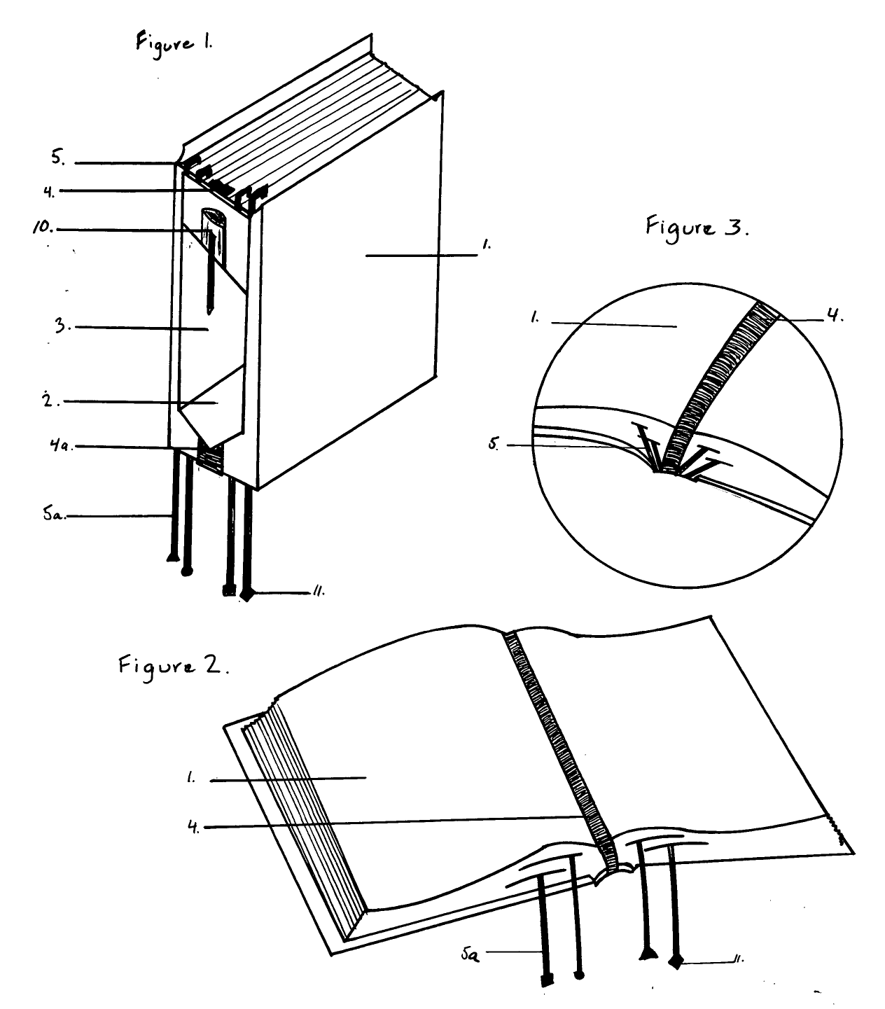

FIG. 1 is a perspective view of the Attachable Passage Bookmark with Pen Pocket. The bookmark is shown attached to a book 1 and being used to mark pages in that book. The front of the bookmark 2 is on the outside spine of the book. The outside pocket 3 will accommodate a writing instrument. The adjustable anchor strap 4 extends out of the top upper portion of the bookmark and down through the center of the book between the pages of the book. The adjustable anchor strap's 4a free end extends downward, parallel to the book's spine and beyond the lower edge of the book's pages and is brought up and behind the lower portion of the bookmark. The adjustable anchor strap's free end passes through the first ring and then the second ring. The anchor strap's free end then reverses direction, bypassing over the second ring and then passes back through the first ring. The adjustable anchor strap is pulled taut. The narrow fabric markers 5 extend out of the top portion of the bookmark, over the books spine and down through the pages of the book, parallel to the book spine. The ends of the narrow fabric markers 5a extend beyond the lower edge of the book spine. Each of the marker ends is equipped with a different tab, charm or bead element.

FIG. 2 is a perspective view of the bookmark, which is attached to a book 1, with the book shown in an open position. FIG. 2 illustrates how the adjustable anchor strap 4 passes through the center of the book from the top of the book to the bottom of the book and then wraps around the lower book spine. The plurality of narrow fabric markers 5a provides for marking a multiple of pages in the book. Each page marked further defined by a different color, tab, charm or bead element attached to the end of each narrow fabric marker.

FIG. 3 is an enlarged close up of the bookmark, which is attached to book 1 shown in an open position. The view is of the upper spine and illustrates how the adjustable anchor strap 4 is placed in the center of the book's pages and then extends down to the bottom of the book. FIG. 3 also shows how the narrow fabric markers 5 are placed between pages to mark those pages.

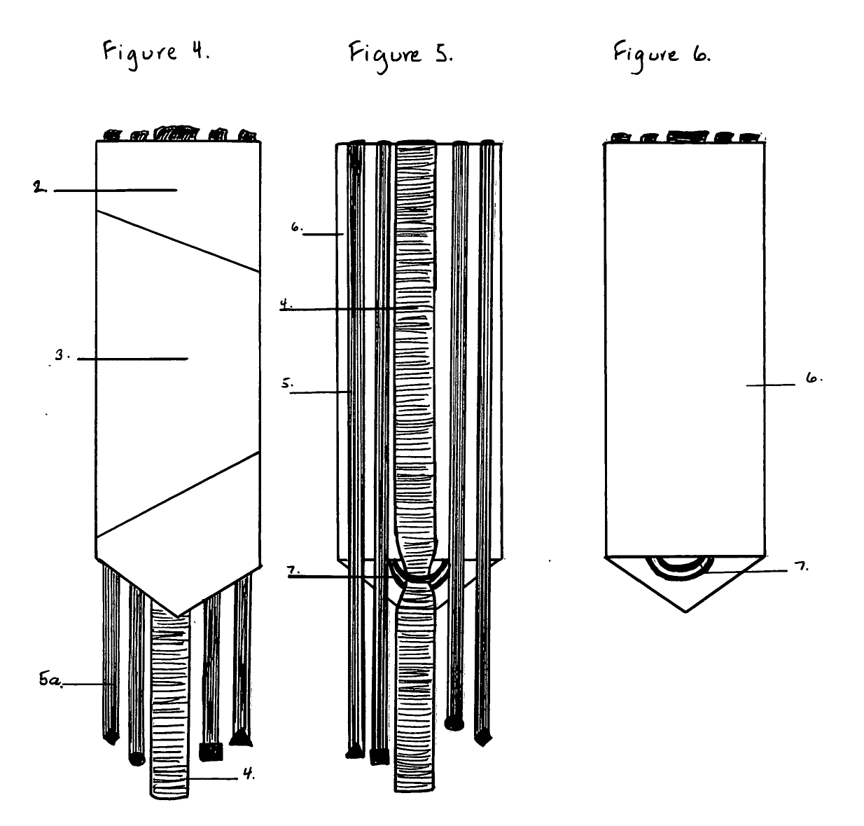

FIG. 4 is a view of the bookmark front 2 showing the front pen pocket 3, the adjustable anchor strap 4, which secures the bookmark to the book, and the narrow fabric markers 5a for marking multiple pages in the book. Each of the narrow fabric markers is equipped with a different tab, charm or bead on each of its end to distinguish one marked page from another.

FIG. 5 is a view of the bookmark back 6 showing the adjustable anchor strap 4, which secures the bookmark to the book, and the narrow fabric markers 5 for marking multiple pages in the book. Each marker being equipped with a different tab on it's end. Also shown are the two rings 7 through which the adjustable anchor strap 4 passes. The strap, having been passed through the first ring, then the second ring, then reverses direction, bypassing over the second ring and then passes back through the first ring. The adjustable anchor strap 4 is pulled taut, thus securing the bookmark to the book.

FIG. 6 is a view of the bookmark back 6, with the adjustable strap and narrow fabric markers shown in partial view only. This view shows the two rings 7 through which the adjustable strap passes for the purpose of pulling the strap taut, thereby securing the bookmark to the book.

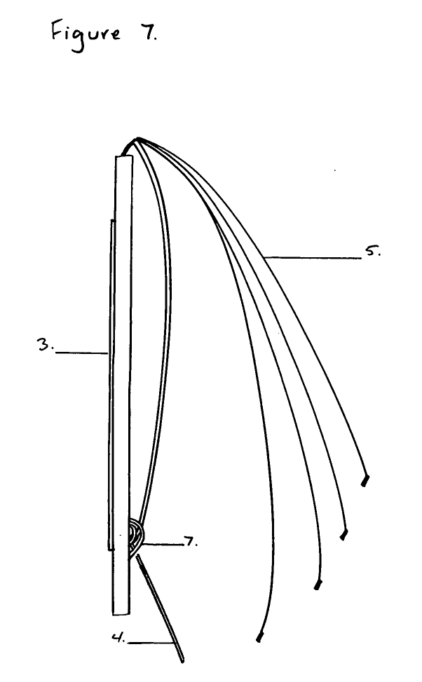

FIG. 7 is a side view of the bookmark, which shows the main body of the bookmark, the front pocket 3, the adjustable strap 4, narrow fabric markers 5 and the two rings 7. The adjustable strap is shown passing through the two rings.

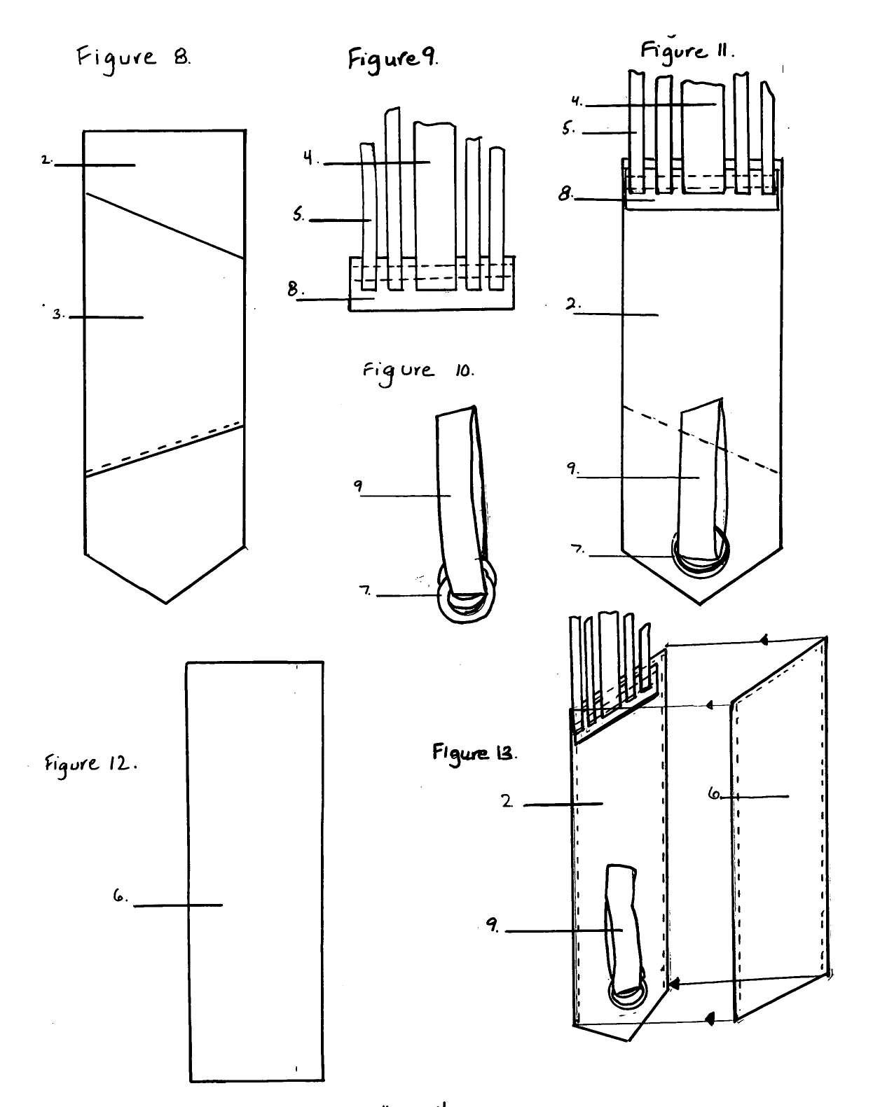

FIG. 8 is a view of the topside of the front piece 2, showing the placement of the front pen pocket 3 on the topside of the front piece. The bottom edge of the front pocket is attached to the front piece at the dotted line as shown in FIG. 8.

FIG. 9 is a view of the adjustable anchor strap 4 and narrow fabric markers 5, which are affixed to a stabilizing piece 8. The stabilizing piece (with adjustable strap and narrow fabric makers attached) will be attached to the underside of the front piece 2. Different tabs, charms or beads will be attached to the narrow fabric markers at this stage of assembly.

FIG. 10 is a view of the short length strap 9, which goes through the two rings 7 creating a loop, which holds two rings. The short length strap will be attached to the underside of the front piece 2.

FIG. 11 is a view of the underside of the front piece 2, showing placement of the stabilizing piece 8 (with the adjustable strap 4 and narrow fabric markers 5 as described in FIG. 9). Also shown is the placement of the short length strap 9, which loops around the two rings 7 as described in FIG. 10. The short length strap 9 is attached to the underside of the front piece 2 at the dotted line as shown in FIG. 11. (The dotted line shown in FIG. 11 is the underside of the dotted line shown in FIG. 8, which attaches the bottom edge of the front pocket.)

FIG. 12 is a view of the underside of the back piece 6.

FIG. 13 is a view showing the joining of the front of bookmark 2 to the back of bookmark 6. The two pieces will be placed, undersides together, with top and long side edges even. The top edges and long side edges will be joined. The dotted lines shown in FIG. 13 indicate the common line of attachment of the front of bookmark 2 to the back of the bookmark 6. The adjustable anchor strap and narrow fabric markers, being sandwiched between the front and back of the bookmark, will be permanently affixed to the upper portion of the bookmark upon the joining of the front and back. The adjustable anchor strap and narrow fabric markers will extend out from the joined upper portion of the bookmark. The short length strap 9 with rings will hang freely, as the bottom edges are not joined. Upon joining of the front of bookmark 2 to the back of bookmark 6, the front of the bookmark will appear as in FIG. 4, while the back of the bookmark will appear as in FIG. 5.

From the foregoing it will be understood that the present invention may be of various sizes, materials, components, operational features and the like. The bookmark of the present invention can be made from any suitable material, examples of which include fabric and leather. Construction methods employed should be appropriate to the materials being used. Alternate construction and equivalents may be employed without departing from the spirit and scope of the invention.

1. An attachable passage bookmark with pen pocket comprising:
a thin elongated body, the length and width of which to fit the average book's outer spine, having a separate front surface and a separate back surface which are joined together,
the front surface of which incorporates a pocket for holding a pen or other desirable writing instrument;
the elongated body having an upper and lower portion;
the upper portion securing a plurality of narrow fabrics of varying lengths, sufficient in length so as to extend over the top spine of the book, down through the book's pages, running parallel to the spine of the book, and extending beyond the lower spine of the book, below the book's pages, and having defining characteristics for the purpose of marking and differentiating a multiple of pages within a book;
the upper portion also securing an anchor strap sufficient in length so as to extend over the top spine of the book, down through the book's pages, running parallel to the spine of the book, extending beyond the lower spine of the book, below the book's pages; further sufficient in length to pass through a first ring and then a second ring, the rings being accessible from the backside of the lower portion of the bookmark, the anchor strap then reversing direction, bypasses over the second ring and then passes back through the first ring, and being pulled taut secures the bookmark to the book;
the inside lower portion of the bookmark securing a short length strap which passes through two rings creating a secured loop;
